(19) United States
(12) Patent Application Publication
(10) Pub. No.: US 2025/0346395 A1
(43) Pub. Date: Nov. 13, 2025

(54) DRIP TRAY FOR SHELVING

(71) Applicant: Baker Brothers Installations, Inc., Kennesaw, GA (US)

(72) Inventor: Michael Baker, Marietta, GA (US)

(21) Appl. No.: 19/204,944

(22) Filed: May 12, 2025

Related U.S. Application Data
(60) Provisional application No. 63/645,996, filed on May 13, 2024.

(51) Int. Cl. B65D 19/38; A47B 71/00

(52) U.S. Cl. CPC B65D 19/38; A47B 71/00; B65D 2519/008

(57) ABSTRACT

A system includes a roll-out device comprising a first member configured to couple to a fixed frame; a second member slidable relative to the first member; and a locking handle on the second member. The system includes a tray on the second member including a base surface and a perimeter wall defining a liquid collection recess. A drain hole extends through one of the base surface or the perimeter wall allowing a liquid to flow out of the liquid collection recess. The tray is movable between (i) a first configuration wherein the second member is fully retracted within the fixed frame and the locking handle is engaged to prevent movement of the second member, and (ii) a second configuration wherein the second member extends out of the fixed frame and beyond the first member and the locking handle is disengaged to allow movement of the second member.

### CROSS-REFERENCE TO RELATED APPLICATIONS

This application claims the benefit of and priority to U.S. Provisional Application No. 63/645,996, filed May 13, 2024, the entire contents of which are hereby incorporated by reference.

### BACKGROUND

The present disclosure relates generally to inventory management and pallet stacking systems. Pallet racks/frames/shelves provide a variety of sizes and configurations for various applications. However, existing systems fail to account for specific types of inventory storage. For example, existing systems fail to provide a food-safe and clean environment in the case of perishable food storage (e.g., meat and seafood). Therefore, a need exists for pallet racks that provide a clean and efficient solution to food storage.

### SUMMARY

The drip pan system disclosed herein may be installed in a shelving unit for storage of palleted inventory (or, a “pallet rack”). For example, the system may be installed in a shelving unit with pallets of foodstuffs (e.g., produce, meat, dairy, seafood, or other perishable food product). In some cases, especially for meat or seafood, the pallet of food product may expel liquid (either via condensation or by expelling melted liquid from the food product itself). The excess liquid may drip from the pallet of food down to the floor below the pallet and/or the pallet on the shelf below the pallet. It is generally undesirable to have dripping food product in a storage facility. Such a situation reduces the food safety and sanitary conditions of the storage facility. Therefore, the devices and systems of this disclosure provide a collection system that is easily adaptable to existing storage systems, providing a sanitary and efficient solution.

One implementation of the present disclosure is a drip pan system including: a roll-out device including a first member configured to couple to a fixed frame; a second member slidable relative to the first member; and a locking handle disposed on the second member; a tray disposed on the second member, the tray including a base surface and at least one perimeter wall defining a liquid collection recess, wherein the tray defines a drain hole extending through one of (i) the base surface or (ii) the at least one perimeter wall, the drain hole allowing a liquid to flow out of the liquid collection recess, wherein the tray is movable between (i) a first configuration wherein the second member is fully retracted within the fixed frame adjacent to the first member and the locking handle is engaged to prevent movement of the second member, and (ii) a second configuration wherein the second member extends out of the fixed frame and beyond the first member and the locking handle is disengaged to allow movement of the second member.

In some implementations, the locking handle is disposed on a front crossbeam of the second member and the locking handle includes a movable latch configured to abut and engage a locking protrusion on the fixed frame.

In some implementations, the locking handle further includes a spring biasing the locking handle in the first configuration.

In some implementations, the tray is dimensioned to accommodate two standard pallets across a width of the tray.

In some implementations, the tray is dimensioned to accommodate two standard pallets across a depth of the tray.

In some implementations, the drip pan system is mounted to the fixed frame below a wire rack configured to allow liquid to drip from a wet product pallet into the liquid collection recess of the tray, wherein the drip pan system is mounted to the fixed frame such that a low profile of the drip pan system is configured to accommodate a pallet on a shelf below the drip pan system.

In some implementations, the drip pan system further includes self-tapping screws engaged through the first member of the roll-out device to couple to a vertical post of the fixed frame.

In some implementations, the tray includes 24 gage steel.

In some implementations, the base surface of the tray is contoured to funnel liquid to a drainage portion of the tray.

In some implementations, the base surface of the tray includes a plurality of angled sections configured to funnel liquid to a drainage portion of the tray.

In some implementations, the drip pan system further includes a valve coupled to the drain hole, the valve being movable between an open and a closed configuration; and a drain hose coupled to and in fluid communication with the valve.

In some implementations, the drip pan system further includes a storage container coupled to and in fluid communication with the drain hose.

In some implementations, the base surface of the tray is angled towards a front side of the tray.

In some implementations, the base surface includes angled sections on either side of a longitudinal axis, wherein each of the angled sections meet at a lower edge of the base surface parallel to the longitudinal axis.

In some implementations, a front perimeter wall defines the drain hole extending therethrough, the drain hole being aligned with an edge of the base surface and configured to allow liquid to flow out of the liquid collection recess.

In some implementations, the valve includes food safe plastic material.

In some implementations, the drip pan system further includes a drain hose coupled to and in fluid communication with the drain hole; and a valve coupled to the drain hose at a distal end, the valve being movable between an open and a closed configuration.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIG. 1A shows an isometric view of a roll-out pallet system, according to one implementation.

FIG. 1B shows a top view of the roll-out pallet system of FIG. 1A.

FIG. 1C shows a front view of the roll-out pallet system of FIG. 1A.

FIG. 1D shows a side view of the roll-out pallet system of FIG. 1A in the open configuration.

FIG. 1E shows a side view of the roll-out pallet system of FIG. 1A in the closed configuration.

FIG. 2A shows the roll-out pallet system of FIG. 1A with a drip tray installed thereon, according to one implementation.

FIG. 2B shows a top view of the roll-out pallet system and drip tray of FIG. 2A.

FIG. 2C shows a front view of the roll-out pallet system and drip tray of FIG. 2A.

FIG. 2D shows a side view of the roll-out pallet system and drip tray of FIG. 2A in the closed configuration.

FIG. 2E shows a side view of the roll-out pallet system and drip tray of FIG. 2A in the closed configuration.

FIG. 3 shows various views of a drip pan, according to one implementation.

FIG. 4 shows various views of a roll-out pallet system having a tray with a drain hole, according to one implementation.

FIG. 5 shows various views of a double-depth roll-out pallet system having a tray with a drain hole, according to one implementation.

FIG. 6A shows various views of a shelving unit with a roll-out pallet system installed, according to one implementation.

FIG. 6B shows an image of a roll-out pallet system.

FIG. 6C shows an image of a roll-out pallet system with one rack in the extended configuration.

FIG. 7A shows various views of a drip pan with a contoured or shaped base and a drain hole defined by a perimeter wall, according to one implementation.

FIG. 7B shows a drip pan system with a liquid collection system, according to one implementation.

FIG. 8 shows an image of a drip pan system installed on a pallet rack or shelving unit, according to one implementation.

FIG. 9 shows an image of a drip pan system installed on a pallet rack or shelving unit with a wire framing above, according to one implementation.

FIG. 10 shows an image of a shelving unit with a plurality of drip pan systems installed on various levels of the shelving unit, according to one implementation.

FIG. 11A shows an installed drip pan system in the closed configuration; FIG. 11B shows the drip pan system of FIG. 11A with a worker about to engage the locked handle; FIG. 11C shows the drip pan system of FIG. 11A with the handle unlocked; FIG. 11D shows the drip pan system of FIG. 11A in the open configuration.

FIG. 12A and 12B show the locking handle of a drip pan system, according to one implementation. FIG. 12C and 12D show a roller system of a roll-out pallet system, according to one implementation.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Referring generally to the figures, a drip pan and drip pan system for a pallet shelf is shown, according to various implementations. Throughout this disclosure, the terms “pan”, “drip pan”, “tray”, and “drip tray” may be used interchangeably to refer to the same or similar devices or features.

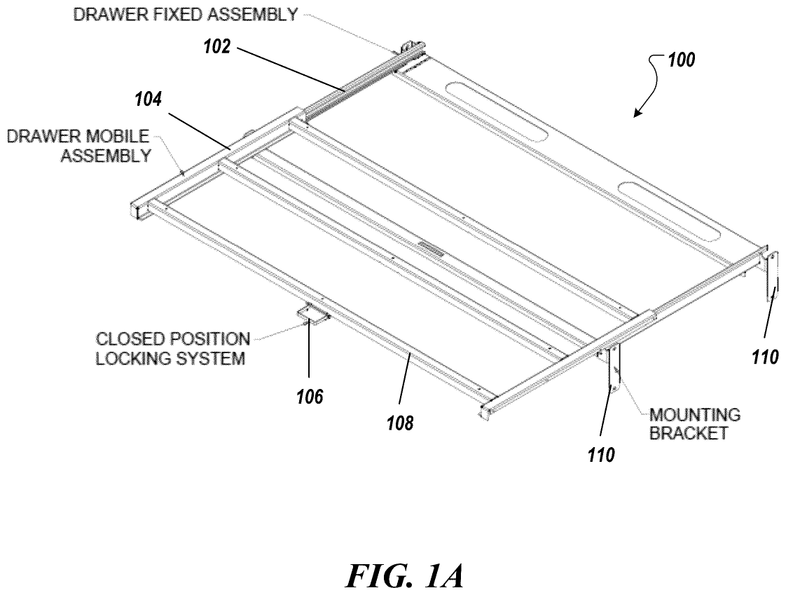

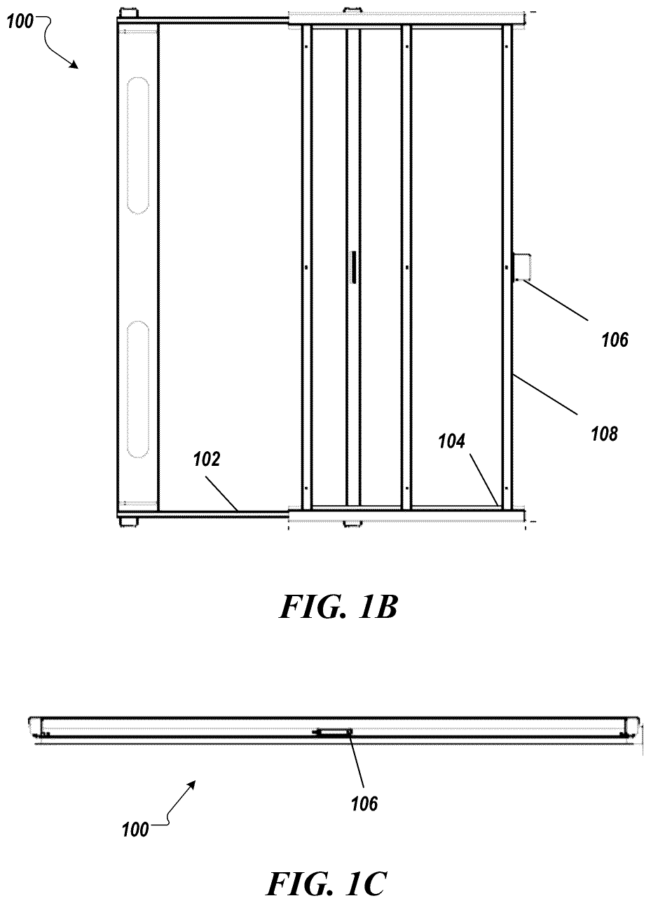

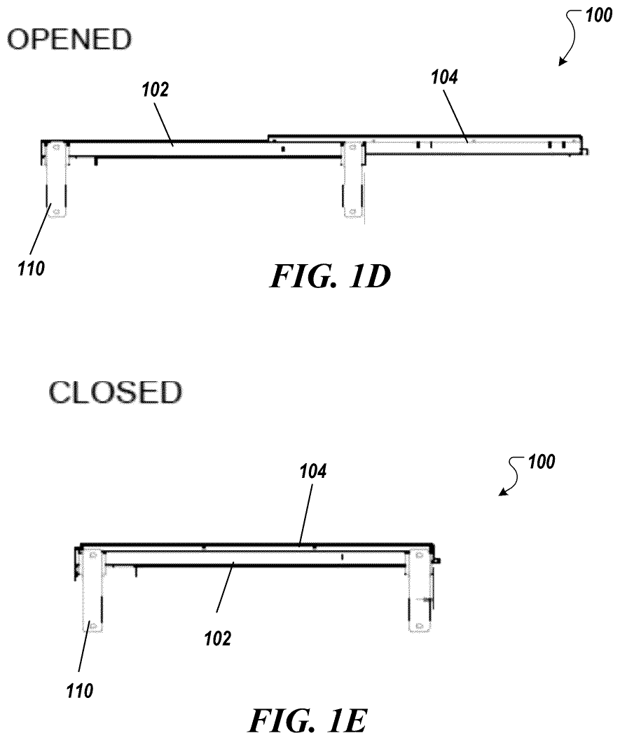

FIGS. 1A-1E show a roll-out pallet device 100, according to one implementation. The roll-out pallet device 100 includes a first member 102 (also shown as “drawer fixed assembly”) and a second member 104 (also shown as “drawer mobile assembly”). The first member 102 is configured to couple to a fixed frame (e.g., a pallet rack or shelf). The second member 104 is slidable relative to the first member 102.

A plurality of mounting brackets 110 are coupled to the first member 102. Specifically, two mounting brackets 110 are shown on either side of the first member 102 for a total of four mounting brackets. The mounting brackets are configured to accept a fastener (e.g., a screw, a bolt, or a self-tapping screw) which extends into a vertical post of the fixed frame, securing the roll-out pallet device 100 to the fixed frame. For example, each mounting bracket 110 may align with a vertical post of a shelving unit, and one or more fasteners may be used to couple the mounting bracket 110 to the corresponding vertical post of the shelving unit.

Once the mounting brackets 110 are coupled to a shelving unit, the first member 102 is fixed relative to the shelving unit and configured to support the second member 104. For example, one or more rollers, bearings, sliders, or other drawer-slide devices are disposed between the first member 102 and the second member 104 (e.g., in a channel defined therebetween). The rollers, bearings, or sliders enable the second member 104 to slide along the first member 102 in a first direction. Thus, the second member 104 is moveable along the first member 102 between a closed configuration and an open configuration, or any point therebetween. The second member 104 may be selectively moveable (e.g., by a user) to “pull out” from a shelving unit to which the first member 102 is coupled.

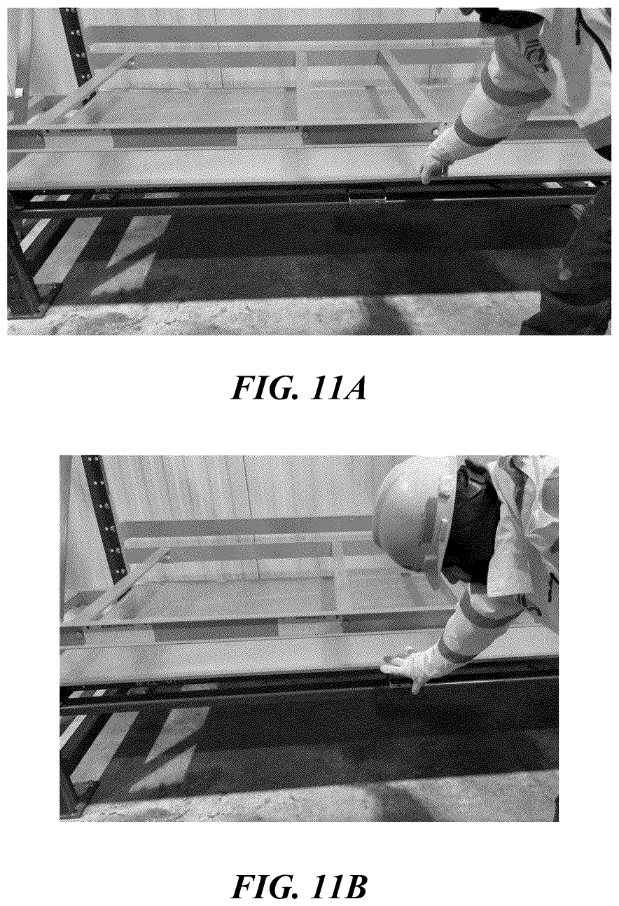

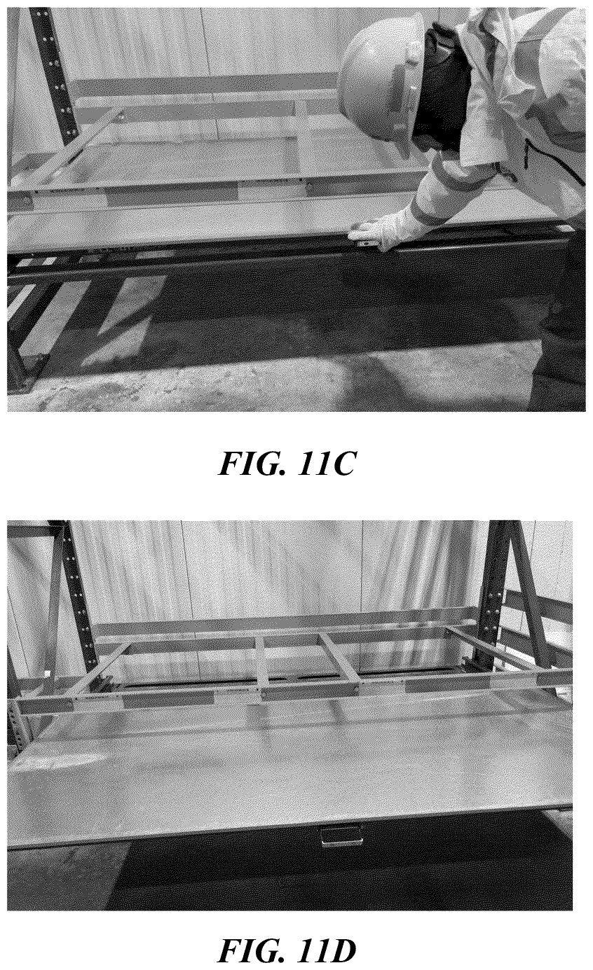

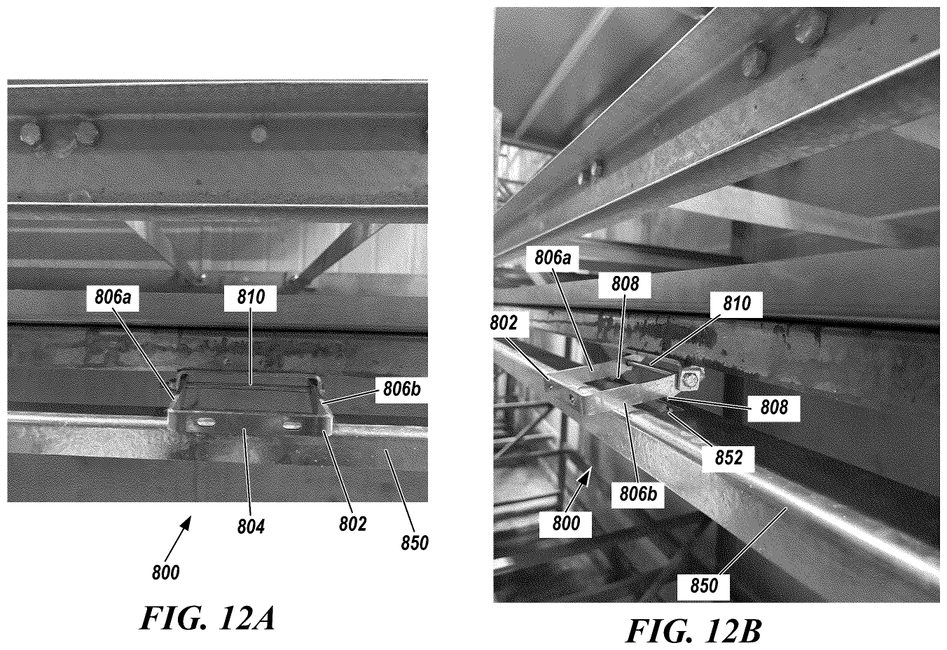

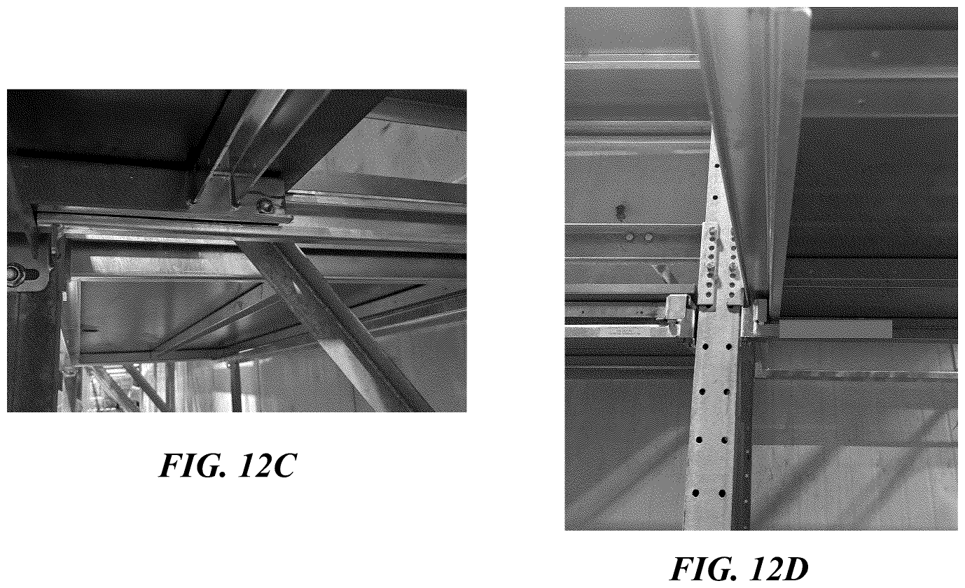

A locking handle 106 is disposed on a front crossbeam 108 of the second member 104. As shown in further detail in FIGS. 11A-12B, the locking handle 106 includes a movable latch configured to abut and engage a locking protrusion or a locking hole defined on the fixed frame (e.g., a cross beam of the shelving unit). In some implementations, the locking handle further includes a spring biasing the locking handle in the first or closed configuration. The locking handle 106 is generally movable in an upward and downward direction relative to the roll-out pallet device 100, which may be perpendicular to the first direction of the sliding second member 104. However, in other implementations, the locking handle may be moveable in a different direction (e.g., towards a side of the shelving unit or rotationally moveable).

The roll-out pallet device 100 shown in FIGS. 1A-1E is 96 inches wide and 44 inches deep. Therefore, the roll-out pallet device 100 is dimensioned to accommodate two pallets side-by-side (e.g., a 2×1 arrangement). These dimensions are exemplary only and do not limit the scope of the disclosure. In other implementations, the roll-out pallet device is a different size dimensioned to accommodate a different number of pallets (e.g., four pallets arranged 2×2, two pallets arranged 1×2, or a single pallet). Throughout this application, including the figures and associated descriptions, all dimensions are in inches unless otherwise states and are illustrative only. Various depths, heights, and widths of the tray and overall drip pan system are contemplated by this disclosure.

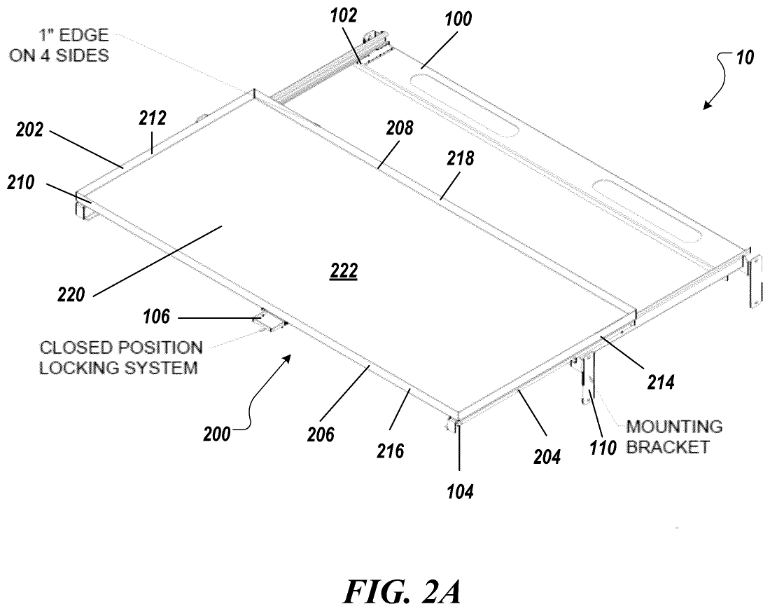

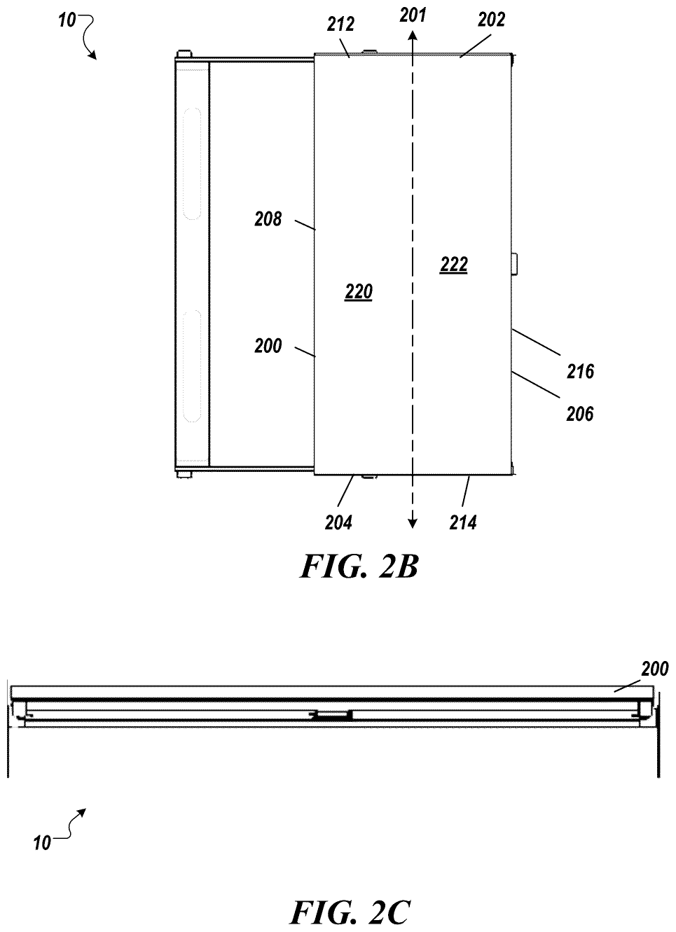

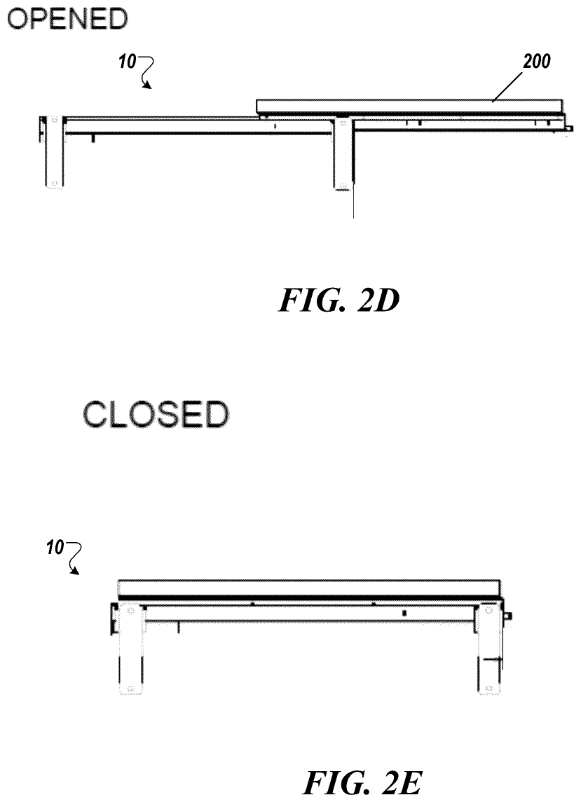

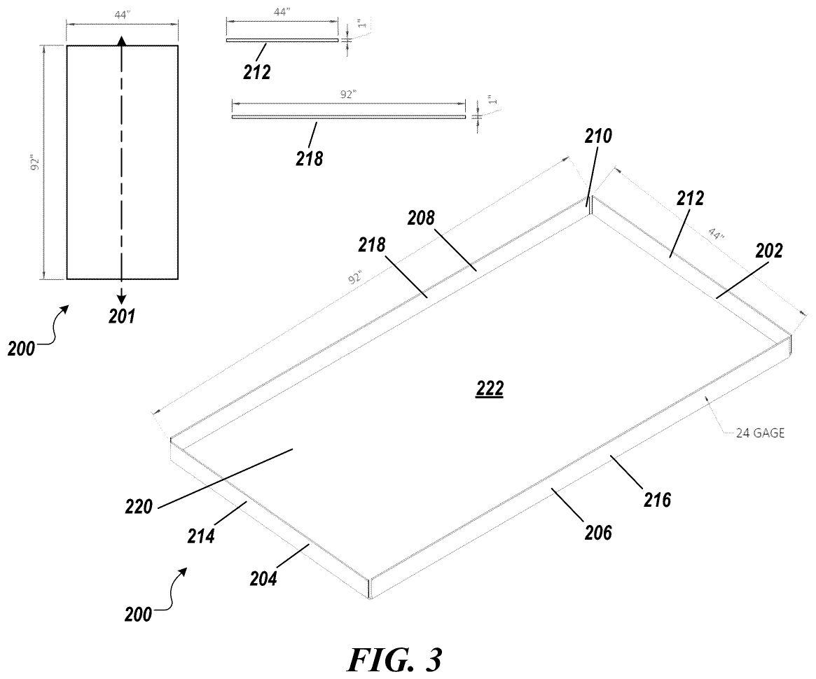

FIGS. 2A-2E show a drip pan system 10 including the roll-out pallet device 100 of FIG. 1A along with a tray 200 disposed on top of the second member 104 of the roll-out pallet device 100. FIG. 3 shows various views the tray 200 along with associated dimensions, which are exemplary only. The tray 200 comprises 24 gage aluminum. However, in other implementations, the tray comprises a different type and size of material (e.g., steel, plastic, or aluminum of a different gage).

As shown in FIGS. 2A and 2B, the tray 200 has a longitudinal axis 201 extending between a first side 202 and a second side 204 of the tray 200. The tray 200 includes a base surface 220. The tray 200 further includes a perimeter wall 210 including a first side wall 212 on the first side 202, a second side wall 214 on the second side 204, a front side wall 216 on a front side 206 of the tray 200, and a back side wall 218 on a back side 208 of the tray 200. The perimeter wall 210 extends upwards from the base surface 220 to define a liquid collection recess 222. Specifically, the liquid collection recess 222 is defined between the perimeter wall 210 and the base surface 220.

The tray 200 is coupled to the roll-out pallet device 100. Specifically, the tray 200 is coupled to the slidable second member 104 of the roll-out pallet device 100. For example, the tray 200 be disposed on top of the second member 104 and one or more cross beams thereof. The tray 200 may be coupled to the second member 104 with one or more fasteners. For example, one or more rivets, screws, or other fasteners may extend through the base surface 220 of the tray 200 to couple to a portion of the second member 104 (e.g., a cross beam or side beam thereof). The fasteners coupling the tray 200 to the second member 104 may be sealed or at least shaped to form a seal on the base surface 220 such that the liquid collection recess 222 does not leak at the fastener location.

The tray 200 is movable between a first configuration (or a closed configuration) and a second configuration (or an open configuration). Specifically, the tray 200 is moveable with the second member 104 of the roll-out pallet device 100 in the first direction (e.g., a direction extending between the front side 206 and the back side 208 of the tray 200). In the first configuration, the second member 104 and the tray 200 disposed therein are fully retracted within the fixed frame (e.g., the shelving unit). In the first or closed configuration, the locking handle 106 is engaged to prevent movement of the second member 104. For example, the locking handle 106 may be engaged with a recess or protrusion formed on a crossbeam of the fixed frame, preventing forward motion of the second member 104.

In the second configuration, the second member 104 and the tray 200 disposed thercon extend out of the fixed frame (e.g., sliding along the first member 102). In the second or open configuration, the locking handle 106 is disengaged to allow movement of the second member 104. The second member 104 may slide until the back side 208 of the tray 200 is nearly aligned with a front edge of the first member 102 (e.g., a distance less than or equal to the depth of the tray as measured between the front side 206 and the back side 208).

FIG. 3 shows exemplary dimensions of the tray 200, which can accommodate two standard sized pallets. For example, the base surface 220 has an area large enough to extend underneath two pallets of product disposed on a shelf above the tray 200. Thus, the liquid collection recess 222 can collect dripping liquid from the two pallets of product disposed above the tray 200. In other implementations, the tray may have various other shapes and/or dimensions configured to capture dripping fluid from differently shaped and sized items.

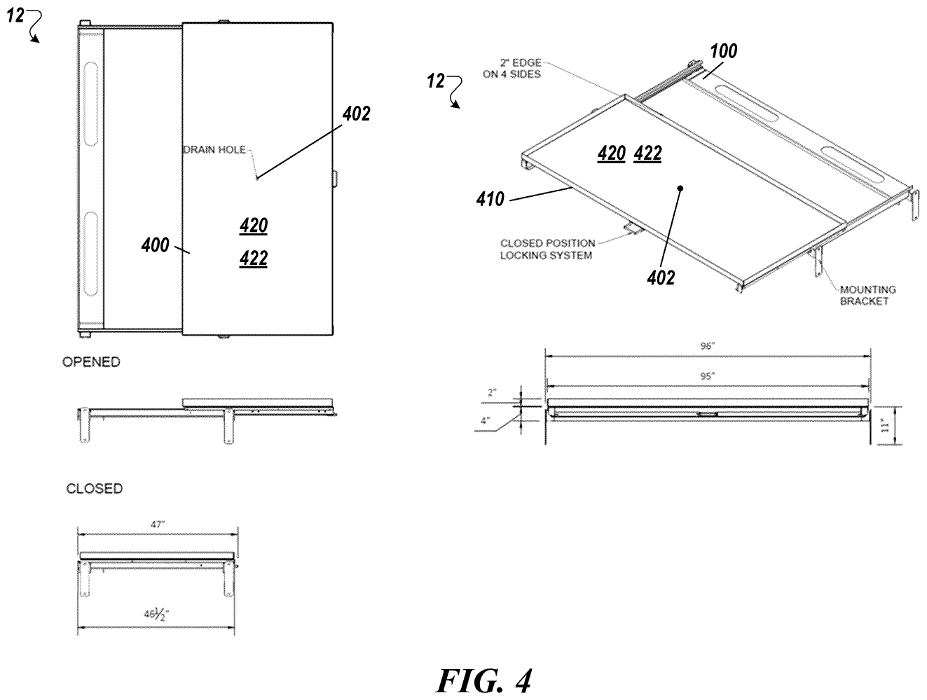

FIG. 4 shows a system 12 including the roll-out pallet device 100 of FIG. 1 along with a tray 400. The tray 400 is substantially similar to the tray 200 of FIGS. 2 and 3, except as described below. The tray 400 includes a base surface 420 and a perimeter wall 410 defining a liquid collection recess 422. However, the tray 400 includes a drain hole 402 extending through the base surface 420. The drain hole 402 is defined by and extends though a central portion of the base surface 420. In other implementations, the drain hole is defined by a different portion or location of the base surface of the tray. In other implementations, the drain hole is defined by and extends through one of the perimeter walls.

The drain hole 402 allows a liquid in the liquid collection recess 422 to drain out of the tray 400. For example, the drain hole 402 is configured to remove collected liquid in the liquid collection recess 422 when the tray 400 is being cleaned or re-used. In some implementations, the drain hole includes a removeable drain plug.

In use, the system 12 may be installed in a shelving unit for storage of palleted inventory (or, a “pallet rack”). For example, the system 12 may be installed in a shelving unit with pallets of foodstuffs (e.g., produce, meat, dairy, seafood, or other perishable food product). The individual shelves of the pallet rack often include a grate or perforated metal surface allowing fluid flow therebetween. In some cases, especially for meat or seafood, the pallet of food product may expel liquid (either via condensation or by expelling melted liquid from the food product itself). The excess liquid may drip from the pallet of food through the grate and down to the floor below the pallet and/or the pallet on the shelf below the pallet. It is generally undesirable to have dripping food products in a storage facility. Such a situation reduces the food safety and sanitary conditions of the storage facility.

By installing the system 12 with the tray 400 (or the system 10 with the tray 200, or any other similar system disclosed herein), the tray 400 is situated directly underneath the pallet of food product. Several systems 12 may be installed such that each pallet is disposed above a tray 400. Once the food product on the pallet begins dripping the excess liquid, the tray 400 collects the excess liquid in the liquid collection recess 422. Thus, the liquid is retained and prevented from contaminating other portions of the storage facility.

In the case of the tray 200, the liquid collection recess 222 retains the liquid until such that a cleaning operation may be performed. For example, a worker may pull the handle 106 of the roll-out pallet device 100 to release the second member 104 with the tray 200. Then, the worker can roll out the tray 200, moving the system 10 from the closed to the open configuration. Afterwards, a cleaning operation occurs (e.g., vacuuming up the excess liquid, drying the excess liquid with a paper-based product, wiping the tray clean with a sanitizing agent, or other steps to remove the liquid from the tray).

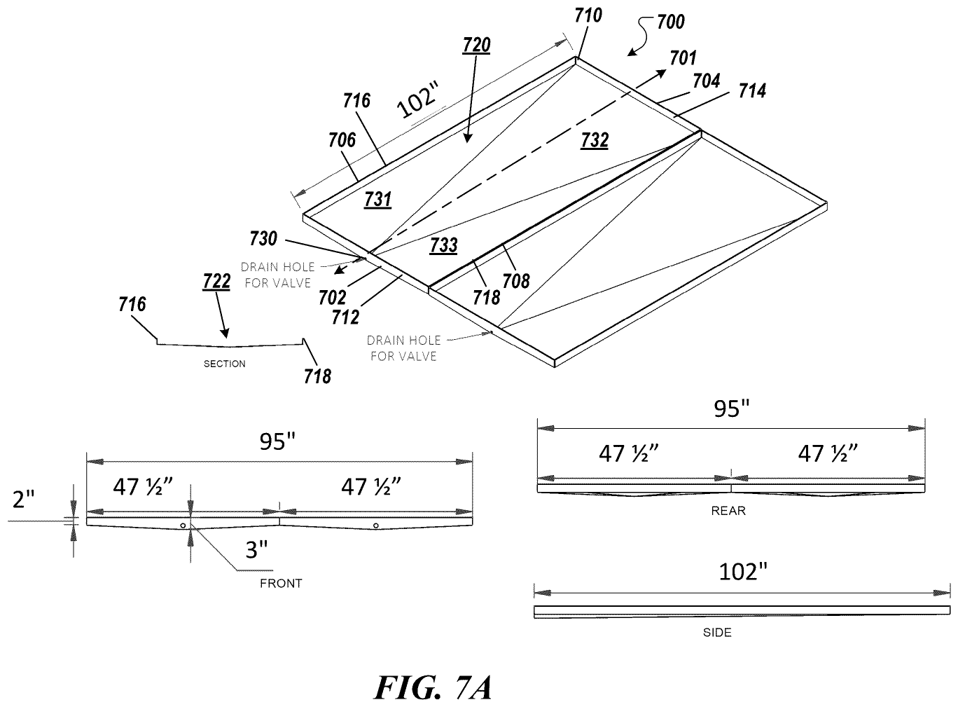

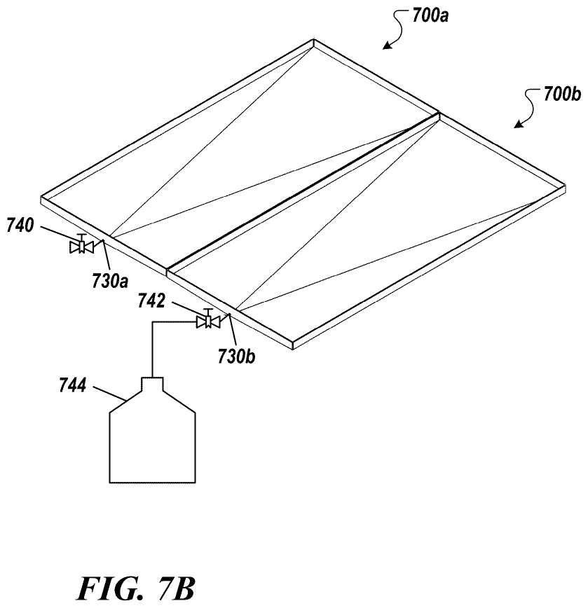

In the case of the tray 400, the drain hole 402 facilitates the cleaning process. For example, the drain hole 402 may be coupled to a separate hose, conduit, or valve system (e.g., see FIG. 7B). The drain hole 402 may be coupled to a storage container separate from the pallet rack such that a worker needs only to empty or replace the storage container. The drain hole 402 may be coupled to a moveable valve with a hose such that a worker needs only to turn the valve to allow the liquid to drain from the tray 400 into a secondary container. In some implementations, the tray 400 is rolled out from the pallet rack for cleaning, inspection, or replacement. In some implementations, the tray of this disclosure is installed directly onto the pallet rack without the need for a roll-out pallet system. For example, with a drain hole and draining system, the tray need not be rolled out from the pallet rack, but it can be drained in-place underneath the pallet.

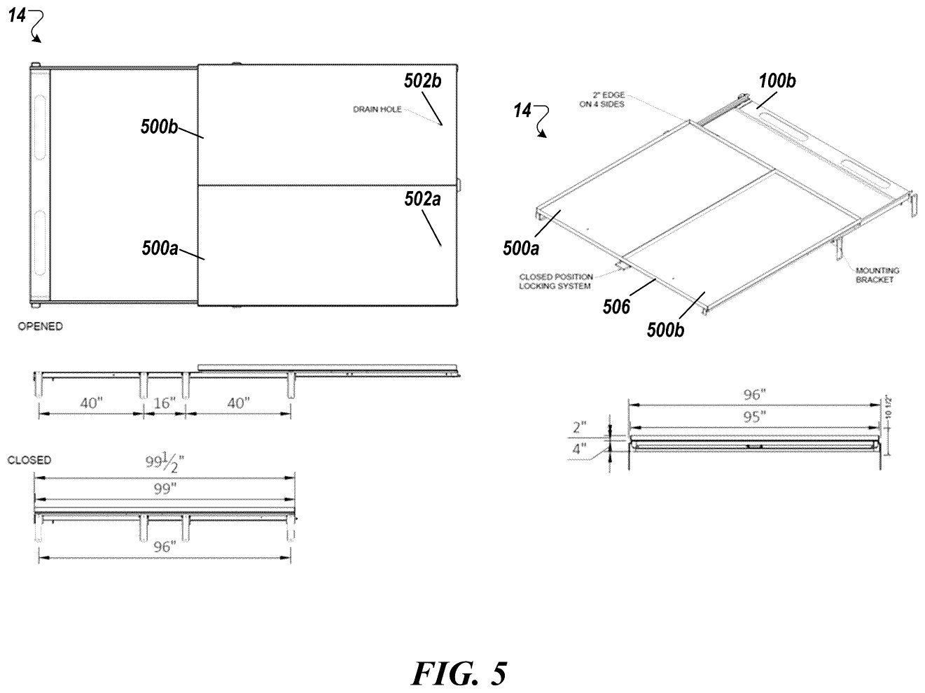

FIG. 5 shows a system 14 that is substantially similar to the system 12 of FIG. 4, except as described below. The system 14 includes a roll-out pallet device 100b dimensioned for four pallets (in a 2×2 configuration). The system 14 further includes two trays 500a, 500b each dimensioned to accommodate two pallets. Thus, the roll-out pallet device 100b and the trays 500a, 500b have a different and/or larger shape than the roll-out pallet device 100 and the tray 200.

The drain hole 502a, 502b of each tray 500a, 500b is arranged closer to the front side 506 of the tray 500a, 500b. However, in other implementations, the drain hole could be arranged in a different portion of the base surface or in one of the perimeter walls.

FIG. 5 shows exemplary dimensions of the system 14. However, in other implementations, the system may have different dimensions and/or configurations. Throughout this disclosure, it is contemplated that any feature, dimension, or alternative described with reference to one example is equally applicable to any other example.

In other implementations, the system could include one large tray covering the 2×2 pallet area. In other implementations, the system could include more than two trays in the system. In other implementations, the trays could have a different geometry, dimensions, and orientation from each other.

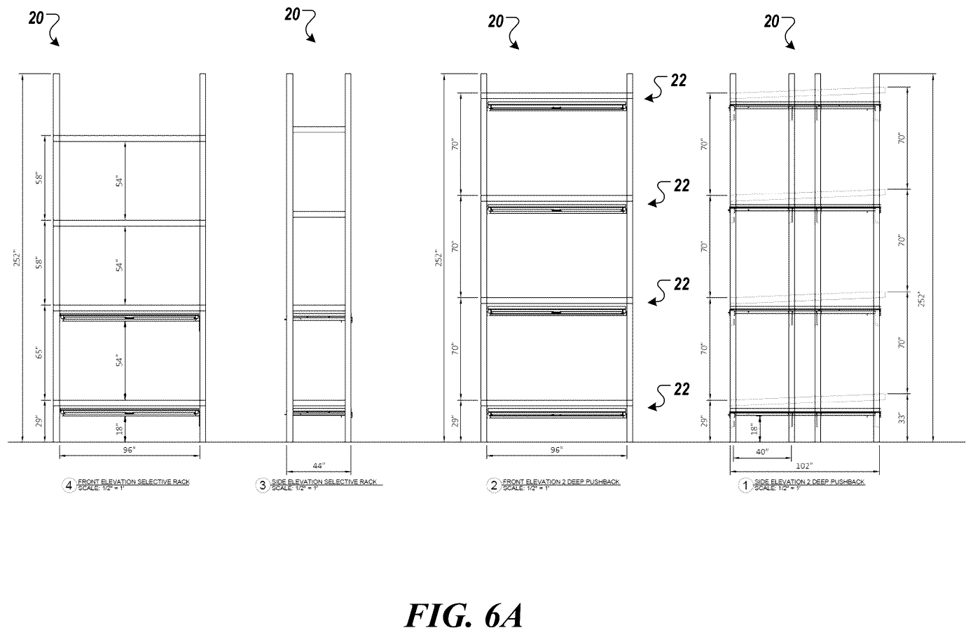

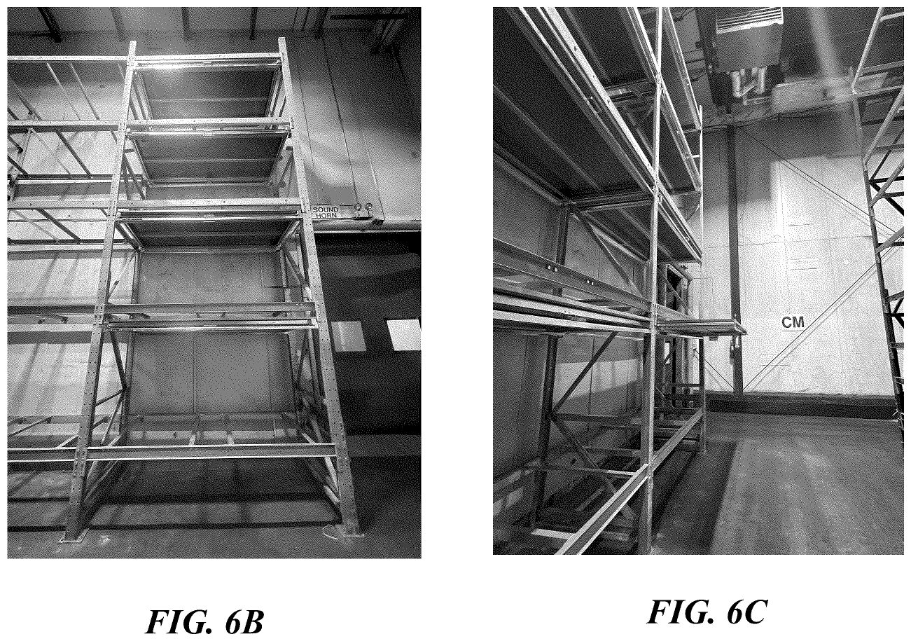

FIG. 6A shows a pallet rack 20 from different views, the pallet rack 20 including four drip pan systems 22, each including a roll-out pallet device (e.g., the roll-out pallet device 100) and a tray (e.g., the tray 200). The drip pan systems are installed at various heights on the pallet rack 20. In some implementations, a different number of drip pan systems are installed on the pallet rack (e.g., 1, 2, 3, 5, 6, 7, 8, 9, 10, 12, 15, 20, or 22 drip pan systems). In some implementations, one drip pan system is installed under each shelf or each pallet of an entire pallet rack or pallet rack system in a warehouse. In some implementations, one or more drip pan systems are installed at an angle relative to the shelf such that liquid may drain towards a desired portion of the tray.

FIG. 6B shows an image of a pallet rack similar to that of FIG. 6A with four drip pan systems installed thereon. FIG. 6C shows the same pallet rack of FIG. 6B from a side view with one of the drip pan systems in the open configuration.

FIG. 7A shows various views of a tray 700 for use in a drip pan system of this disclosure. For case of understanding, only one of the trays 700 shown in FIG. 7A will be discussed and referenced. However, it is contemplated that two or more trays may be used in a drip pan system. The tray 700 is substantially similar to the other trays described herein (e.g., tray 200 or tray 400) except as described below. The dimensions shown in FIG. 7A concerning the tray 700 are exemplary only and do not limit the scope of the disclosure.

The tray 700 has a longitudinal axis 701 extending between a first side 702 and a second side 704 of the tray 700. The tray 700 includes a base surface 720. The tray 700 further includes a perimeter wall 710 including a first side wall 712 on the first side 702, a second side wall 714 on the second side 704, a front side wall 716 on a front side 706 of the tray 700, and a back side wall 718 on a back side 708 of the tray 700. The perimeter wall 710 extends upwards from the base surface 720 to define a liquid collection recess 722.

A drain hole 730 is defined in the first side wall 712 of the perimeter wall 710 to facilitate drainage of liquid from the liquid collection recess 722. The drain hole 730 is located lower on the front side wall 712—close to the base surface 720—to facilitate drainage of the liquid.

The base surface 720 of the tray 700 is contoured to funnel liquid towards the drain hole 730 (or a “drainage portion” of the tray 700 adjacent to the drain hole 730). The base surface 720 includes three angled sections 731, 732, and 733, forming the contoured base surface. The angled section 731 abuts the front side wall 716 and part of the first side wall 712. The angled section 733 abuts the back side wall 718 and part of the second side wall 714. The angled section 732 sits in between the angled section 731 and the angled section 733, abutting the second side wall 714. The angled section 732 generally lies along the longitudinal axis 701 and is angled away from the second side wall 714 towards the first side wall 712 and the drain hole 730.

The angled sections 731, 732, 733 of the base surface 720 urge any liquid in the base surface 720 towards the drain hole 730. In some implementations, greater than three sections of the base surface are provided to funnel the liquid towards the drain hole (e.g., 4, 5, 6, 7, 8, 9, or 10 individual sections. In some implementations, only one or two sections are provided. In some implementations, one or more sections of the base surface are curved or arcuate, in contrast to the sharp angles of tray 700. In some implementations, a combination of curved and sharp sections are provided in the base surface of the tray.

FIG. 7B shows a drip pan system with a tray 700a and a tray 700b, each similar to the tray 700 of FIG. 7A. However, the drip pan system of FIG. 7B further includes devices and systems facilitating the removal of liquid from the liquid collection recesses 722 of the trays 700a, 700b.

The drain hole 730a of the tray 700a is coupled to a valve 740 (e.g., via a conduit or drain hose, or directly coupled). The valve 740 is movable between an open and a closed configuration. In the open configuration, the valve 740 allows a liquid to flow from the liquid collection recess, through the drain hole 730a, and out of the tray 700a. In the closed configuration, the valve 740 prevents the flow of liquid out of the tray 700a.

Similarly, the drain hole 730b of the tray 700b is coupled to a valve 742 (e.g., via a conduit or drain hose, or directly coupled). The valve 742 is similarly movable between an open and a closed configuration. However, the valve 742 is further coupled to, and in fluid communication with, a storage container 744 (e.g., via a second conduit or drain hose). The storage container 744 receives and stores liquid from the tray 700 for disposal or collection.

Each of the valve 740 and the valve 742 includes a food safe plastic material compatible with the excess liquid dripping from the food product on the pallet above the tray 700a, 700b. In some implementations, the valve is securely coupled to the tray to prevent accidentally dislodging and loss of the valve, which is undesirable in food storage applications. In some implementations, the valve is movable via a user/worker to drain the liquid at a desired time and into a desired container. In some implementations, the valve is automatically actuated (e.g., via a controller in communication with a motor coupled to the valve) to drain the liquid according to a preset schedule.

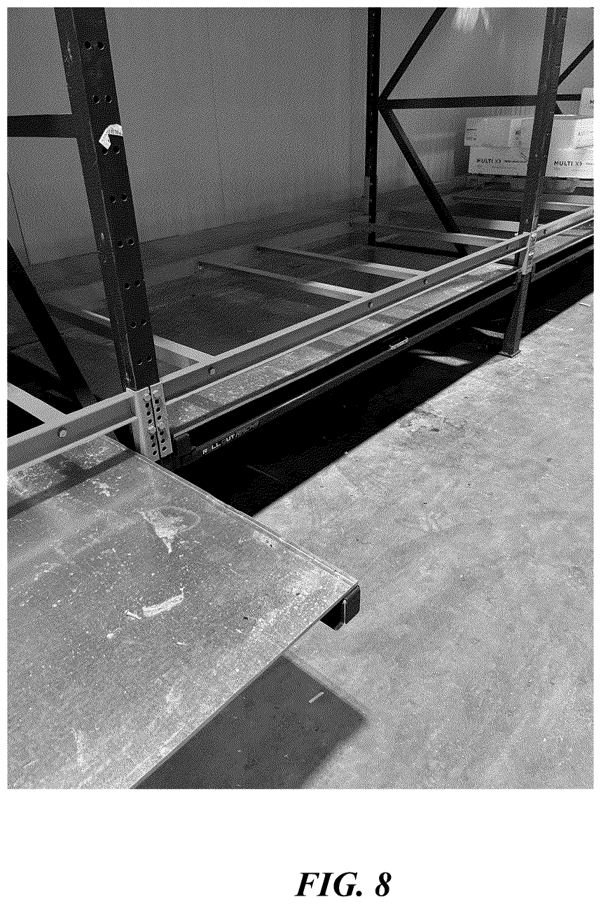

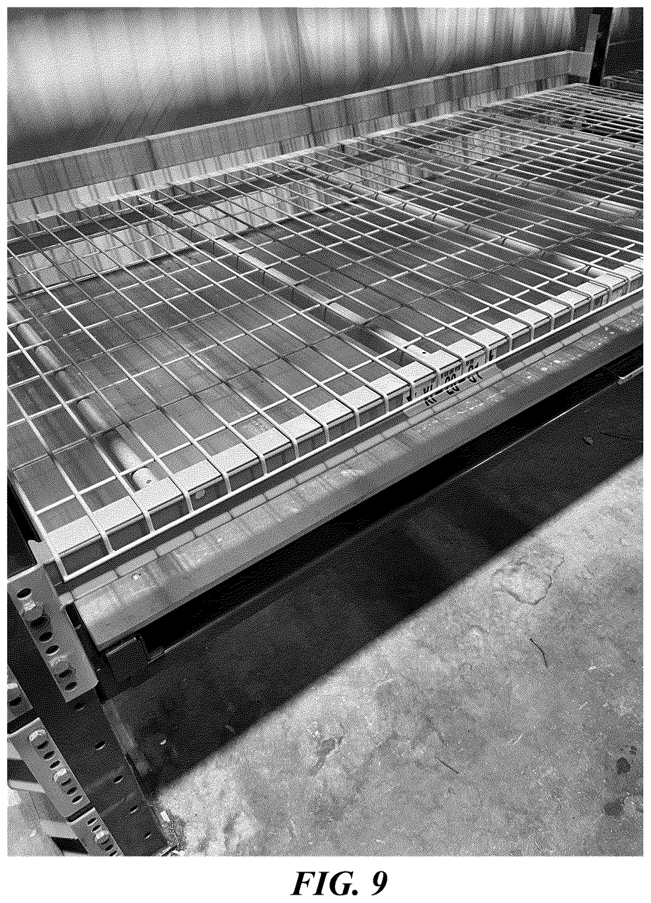

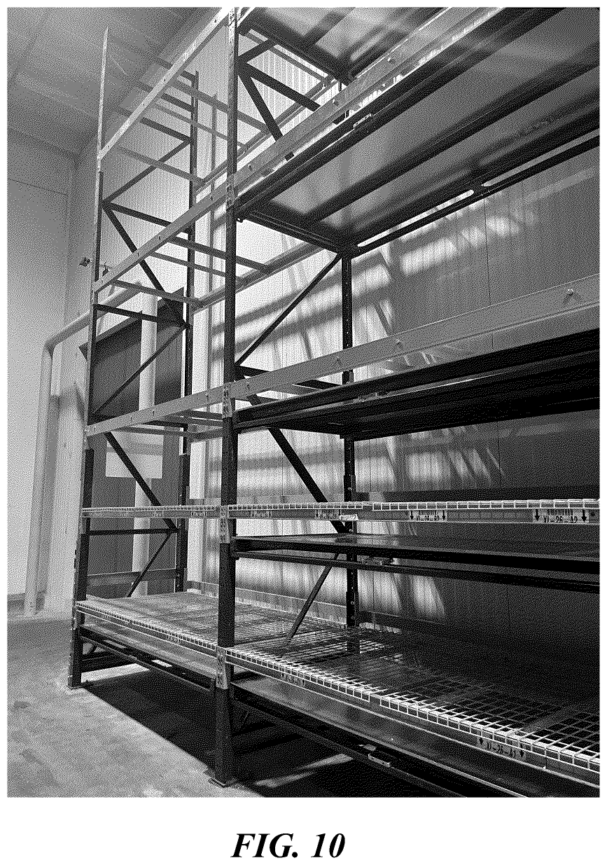

FIGS. 8-10 show images of a drip pan system installed in a pallet rack. As best shown in FIG. 9, the grates extending across the pallet rack form the shelf for individual pallets. Excess liquid dripping from a food storage pallet falls through the grate and onto the tray below. The tray is slidable in and out of the pallet rack via the roll-out pallet device (e.g., see the partially extended tray in FIG. 8).

FIGS. 11A-11D show a process of unlocking the locking handle of a roll-out pallet device of a drip pan system and extending the tray into the open configuration. Notably, the grate/shelf of the pallet rack system is removed in FIGS. 11A-11D for case of visualization.

In FIG. 11A, the system/device is in the closed configuration with the locking handle locked (e.g., abutting the front crossbeam). In this state, sliding motion of the tray and second member of the roll-out pallet device is prevented.

In FIG. 11B, a user or a worker engages the locking handle, lifting and/or rotating the handle (e.g., against a spring biasing force) to disengage the handle from the front crossbeam. The motion is easy to accomplish with one hand, as shown. In FIG. 11C, the locking handle is fully rotated into the unlocked position, and the system/device is free to slide outward. In FIG. 11D, the tray has been slid out from the pallet rack along the second member of the roll-out pallet device.

FIGS. 12A and 12B provide detailed images of a locking device 800, which is substantially similar to the locking handle 106 and related locking mechanisms elsewhere described, except as described below. As shown in FIG. 12A and FIG. 12B, the locking device 800 includes a U-shaped handle 802. The U-shaped handle 802 includes a front member 804 and two perpendicular members 806a, 806b extending from the front member 804. Each perpendicular member 806a, 806b includes a shoulder or protrusion 808 extending downward therefrom. The handle 802 is coupled to a pin 810 on a back side of the handle 802. Specifically, the pin 810 extends through each of the perpendicular members 806a, 806b.

The handle 802 is rotatable about the pin 810 (e.g., with the assistance of a spring biasing it to the locked position). For example, application of a force to the front member 804 rotates the handle 802 about the pin 810.

As shown, the locking device 800 is coupled to a slidable member of a roll-out pallet device (e.g., similar to the first member 102 of the roll-out pallet device 100). Furthermore, a crossbeam 850 of a fixed frame (e.g., a pallet rack) is disposed below the locking device 800. The crossbeam 850 defines a locking opening 852.

When in the locked configuration, the protrusion 808 of the handle 802 extends through the locking opening 852. Thus, the protrusion 808 abuts a portion of the crossbeam 850 to prevent forward motion of the sliding member to which the locking device 800 is coupled.

FIGS. 12C and 12D provide detailed images of the rolling system and the interaction between the first and second members of the roll-out pallet device (e.g., the roll-out pallet device 100 having first member 102 and second member 104). As shown, at least one roller/bearing device on one side of the second member rotates and/or slides between a track on one side of the first member. In other implementations, the first member may include the roller/bearing device while the second member includes the track. In some implementations, the first and second members include a series of bearings and/or rollers (e.g., as in a drawer slide mechanism).

### Configuration of Certain Implementations

The construction and arrangement of the systems and methods as shown in the various implementations are illustrative only. Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

What is claimed is:

1. A drip pan system, comprising:
a roll-out device comprising a first member configured to couple to a fixed frame; a second member slidable relative to the first member; and a locking handle disposed on the second member;
a tray disposed on the second member, the tray comprising a base surface and at least one perimeter wall defining a liquid collection recess, wherein the tray defines a drain hole extending through one of (i) the base surface or (ii) the at least one perimeter wall, the drain hole allowing a liquid to flow out of the liquid collection recess,
wherein the tray is movable between (i) a first configuration wherein the second member is fully retracted within the fixed frame adjacent to the first member and the locking handle is engaged to prevent movement of the second member, and (ii) a second configuration wherein the second member extends out of the fixed frame and beyond the first member and the locking handle is disengaged to allow movement of the second member.

2. The drip pan system of claim 1, wherein the locking handle is disposed on a front crossbeam of the second member and the locking handle comprises a movable latch configured to abut and engage a locking protrusion on the fixed frame.

3. The drip pan system of claim 1, wherein the locking handle further comprises a spring biasing the locking handle in the first configuration.

4. The drip pan system of claim 1, wherein the tray is dimensioned to accommodate two standard pallets across a width of the tray.

5. The drip pan system of claim 1, wherein the tray is dimensioned to accommodate two standard pallets across a depth of the tray.

6. The drip pan system of claim 1, wherein the drip pan system is mounted to the fixed frame below a wire rack configured to allow liquid to drip from a wet product pallet into the liquid collection recess of the tray,
wherein the drip pan system is mounted to the fixed frame such that a low profile of the drip pan system is configured to accommodate a pallet on a shelf below the drip pan system.

7. The drip pan system of claim 1, further comprising self-tapping screws engaged through the first member of the roll-out device to couple to a vertical post of the fixed frame.

8. The drip pan system of claim 1, wherein the tray comprises 24 gage steel.

9. The drip pan system of claim 1, wherein the base surface of the tray is contoured to funnel liquid to a drainage portion of the tray that includes the drain hole.

10. The drip pan system of claim 1, wherein the base surface of the tray comprises a plurality of angled sections configured to funnel liquid to a drainage portion of the tray that includes the drain hole.

11. The drip pan system of claim 10, further comprising:
a drain hose coupled to and in fluid communication with the drain hole; and
a valve coupled to the drain hose at a distal end thereof, the valve being movable between an open and a closed configuration.

12. The drip pan system of claim 10, further comprising:
a valve coupled to the drain hole, the valve being movable between an open and a closed configuration; and
a drain hose coupled to and in fluid communication with the valve.

13. The drip pan system of claim 12, further comprising:
a storage container coupled to and in fluid communication with the drain hose.

14. The drip pan system of claim 12, where the valve is comprises food safe plastic material.

15. The drip pan system of claim 1, wherein the base surface of the tray is angled towards a front side of the tray.

16. The drip pan system of claim 1, wherein the base surface comprises angled sections on either side of a longitudinal axis, wherein each of the angled sections meet at a lower edge of the base surface parallel to the longitudinal axis.

17. The drip pan system of claim 16, wherein a front perimeter wall defines the drain hole extending therethrough, the drain hole being aligned with an edge of the base surface and configured to allow liquid to flow out of the liquid collection recess.
